(19) United States
(12) Patent Application Publication
(10) Pub. No.: US 2022/0126559 A1
(43) Pub. Date: Apr. 28, 2022

(54) PROCESS FOR PRODUCING ADHESIVE-FREE LAMINATES

(71) Applicant: Amcor Flexibles North America, Inc., Neenah, WI (US)

(72) Inventors: Daniel C. Vennerberg, Neenah, WI (US); Brett P. Bobko, Oshkosh, WI (US); Jacob A. Lasee, Neenah, WI (US); Kevin P. Nelson, Appleton, WI (US)

(21) Appl. No.: 17/430,542

(22) PCT Filed: Apr. 23, 2019
(86) PCT No.: PCT/US2019/028763

§ 371 Date: Aug. 12, 2021

(51) Int. Cl. B32B 38/00; B32B 27/36; B32B 7/12

(52) U.S. Cl. CPC B32B 38/145; B32B 27/36; B32B 7/12; B32B 2307/514; B32B 2307/31; B32B 2307/7244; B32B 2255/10; B32B 2439/70; B32B 2439/80; B32B 2250/02; B32B 2250/244; B32B 2255/26; B32B 2307/4023

(57) ABSTRACT

A process for producing an adhesive-free laminate is described herein. The process includes printing an ink on a surface of a first film, exposure of the printed film to UV radiation such that the ink is at least partially cured, contacting the first film to a second film such that the ink is between the first and second film, and exposing the combination of the first film, the ink and the second film to a second UV radiation. It has been found that this process can produce a high-quality laminate, without the presence of an adhesive.

### TECHNICAL FIELD

This disclosure is related to a process to produce film laminates without adhesive and the adhesive-free laminates produced thereby. The laminates described herein may be useful for heat-sealable packaging or other applications.

### BACKGROUND

Printed laminates for labels, packaging films or other similar applications are often produced in a manner such that the printed graphics (e.g. indicia or pictures) are trapped between two films. This construction provides protection to the inks, preventing the ink from being scuffed off or otherwise damaged and maintaining a high-quality appearance.

To produce this “trapped print” construction, the converter typically uses a standard printing process to apply ink to the surface of a film. The ink is then dried by the appropriate means (i.e. heated air for water or solvent based inks, high energy radiation for radiation curable inks, etc.). Then, the printed film is attached to a second film, thereby trapping the ink.

One typical approach to attaching the second film is by adhesive lamination. An adhesive material is applied to either one of the films and the films are brought into contact with each other. There are many types of adhesives and application method options known in the industry for lamination of a printed film to another film. The type of adhesive and process used is usually dictated by performance requirements and cost.

The adhesives used for medium- or high-performance applications are typically reactive in nature. The adhesives have two components that are mixed just prior to application and chemically react to form a thermoset, permanently bonding the films. These high-performance adhesives can have a significant cost. The application of these adhesives to the laminate structure adds both material and processing costs to the final product.

Another approach to attaching a film to a printed a film is by a thermal process. This can be done by several known methods including extrusion lamination or thermal lamination. Extrusion lamination involves attaching the second film to the first film using an adhesive polymer heated to the melt phase. Attachment of the films when the surfaces are softened by heat can result in a strong bond strength upon cooling.

These thermal processes for lamination have significant drawbacks. The temperature that is required to create the bond can cause damage to the films and/or the inks, causing them to shrink or have poor appearance properties. Additionally, the materials that work well for thermal adhesion are often specialty type materials that have no other function within the laminate. The addition of these specialty materials for the sole purpose of bonding adds significant cost to the process of lamination.

### SUMMARY

There is a need for a process to produce a simplified laminate structure efficiently. The process preferably avoids one or more of the existing drawbacks. Herein is described an advantageous process to produce a laminate structure including a first film, a second film and an ink between, and attached to, each film. The process includes at least two radiation exposures along with a printing step and a contacting step.

Introduced herein is a process to produce an adhesive-free laminate having at least four steps. One step includes printing a UV radiation sensitive ink on a surface of a first film. Another step includes exposing the first film and the UV radiation sensitive ink to a first UV radiation such that the UV radiation sensitive ink is at least partially cured. Another step includes contacting the first film to a second film such that the UV radiation sensitive ink is between the first film and the second film and the UV radiation sensitive ink is in direct contact with a surface of the second film, resulting in a combination of the first film, the UV radiation sensitive ink and the second film. Another step includes exposing the combination of the first film, the UV radiation sensitive ink and the second film to a second UV radiation. The second UV radiation occurs at a later point in time as compared to the first UV radiation.

The process to produce an adhesive-free laminate may incorporate a first film that is oriented. The first film may contain polyester. The process to produce an adhesive-free laminate may incorporate a second film that has a heat sealant layer and at least one other layer. Either the first or second film used in the process may have an oxygen barrier layer.

In some embodiments of the process to produce an adhesive-free laminate, the UV radiation sensitive ink is configured to relay a visual message. The UV radiation sensitive ink may be less than fully cured after exposure to the first UV radiation. After the exposure to the second radiation, the bond strength between the first film and the second film may be between 30 g/in and 1,000 g/in. After exposure to the second radiation, the bond strength is increased.

The process to produce an adhesive-free laminate may further include heating the combination of the first film, the UV radiation sensitive ink and the second film using an external heating source immediately prior to exposure to the second UV radiation. The external heating source may heat the combination of the first film, the UV radiation sensitive ink and the second film to a temperature between 100° F. and 200° F., or hotter.

In some embodiments of the process to produce an adhesive-free laminate, the second UV radiation impinges the second film before the first film. The process may be executed such that the first UV radiation and the second UV radiation impinge opposite sides of the UV radiation sensitive ink. The process may be executed such that the first UV radiation and the second UV radiation impinge the same side of the UV radiation sensitive ink.

Some embodiments of the process to produce an adhesive-free laminate include a first step of printing a UV radiation sensitive ink on a surface of a first film, a second step of exposing the first film to a first UV radiation such that the UV radiation sensitive ink is at least partially cured, a third step of contacting the first film to a second film such that the UV radiation sensitive ink is between the first film and the second film and the UV radiation sensitive ink is in direct contact with a surface of the second film, the third step resulting in a combination of the first film, the UV radiation sensitive ink and the second film, and a fourth step of exposing the combination of the first film, the UV radiation sensitive ink and the second film to a second UV radiation.

In some embodiments, the process to produce an adhesive-free laminate includes a first, second, third and fourth step as outlined above, carried out sequentially in a single continuous process. The third step of the process may be carried out when the second film is at a temperature below the second film softening point.

An adhesive-free laminate may be produced according to any of the embodiments of the processes described herein. The bond strength of the adhesive-free laminate, measured when separating the first film and the second film may be at least 50 g/in. The adhesive-free laminate may be a heat-sealable packaging film. A heat-sealed package may be made using the heat-sealable packaging film.

### BRIEF DESCRIPTION OF THE DRAWINGS

The disclosure may be more completely understood in consideration of the following detailed description of various embodiments of the disclosure in connection with the accompanying drawings, in which:

FIG. 1 is a schematic of an embodiment of a process used to produce an adhesive-free laminate;

FIG. 2 is a schematic of an embodiment of an adhesive-free laminate;

FIG. 3 is a schematic of another embodiment of an adhesive-free laminate; and

FIG. 4 is a graph showing bond strength as a function of irradiation time for an embodiment of an adhesive-free laminate.

The drawings show some but not all embodiments. The elements depicted in the drawings are illustrative and not necessarily to scale, and the same (or similar) reference numbers denote the same (or similar) features throughout the drawings.

### DETAILED DESCRIPTION

It has been found that an adhesive-free laminate can be produced by way of a specific manufacturing process that includes at least two energy radiation steps. The process results in an adhesive-free packaging structure containing a radiation sensitive ink between a first and second film. The laminate structure includes two films and the material between these films consists of ink. The ink is configured to convey a visual message, such as product or package use instructions. The laminate is processed by a series of UV irradiation steps, increasing the bond strength within the laminate and eliminating the need for an adhesive type material. This process avoids the use of materials that only provide adhesive functionality. The films can be bonded without the use of a typical adhesive, reducing the materials required for the laminate construction and the complexity of producing the laminate.

As will be described in detail herein, typical converting adhesives take several common forms. Typical adhesives for converting films include liquid applied systems, polymeric materials that require higher temperatures to induce bonding and pressure sensitive type adhesives. These special materials are often used for the sole purpose of bonding materials together. These adhesives are not usually visible when looking at the laminate. The adhesive-free laminates described herein do not use adhesives of these types to create a bond between the first film, the ink and the second film. The bond is created by specific processing of the laminate, including two separate UV radiation exposures occurring at two different points in time. This process has the advantages of increased efficiency (no adhesive application) and lower cost (no adhesive materials). The adhesive-free laminate produced by this process has the advantage of case of design (i.e. films and inks do not need to withstand high processing heat).

The adhesive-free laminates described herein may be particularly useful for laminates to be used as labels and packaging films. Heat-sealable packaging films for food, beverages, medical devices, pharmaceuticals, industrial products, consumer goods and other similar products may benefit from the processes taught herein. The elimination of traditional adhesive in these laminates reduces the complexity of the converting process and reduces costs. The laminates disclosed herein are of suitable performance and appearance for these applications. Further, some embodiments of the process described herein avoid the use of high temperatures to achieve bonding, allowing for a wider selection of films and inks, and resulting in a higher quality laminate (i.e. less degradation).

Surprisingly, it was found that a strong bond strength can be achieved between a film that has been printed with a UV radiation sensitive ink and a second film, without the use of adhesive. Advantageously, the laminate structures disclosed herein do not include an adhesive to attach a second film to a printed film. Advantageously, the processes disclosed herein do not include application of an adhesive. Some embodiments avoid potentially damaging processing temperatures.

It has been found that specific processing steps can be used to manufacture the adhesive-free laminates described herein with acceptable bond strength for many applications. The process is less complicated and less expensive to implement than processes that include the incorporation of adhesives for laminate construction. Some processes disclosed herein also have an advantage of requiring lower temperatures, as compared to thermal lamination or extrusion lamination techniques. The lower processing temperature is more favorable when converting films that may be sensitive to high temperatures (i.e. heat-scalable films or heat shrinkable films).

Standard industry practice is to print a UV ink onto a substrate and immediately expose the ink to UV radiation with enough energy intensity and/or duration that the ink is fully cured. Next, a trap printed lamination is created by attaching a second film to the printed film using an adhesive. It has been unexpectedly found that through a change in the converting process, as will be discussed, it is possible to achieve a functional bond between the printed film (the first film) and the second film without an adhesive. Elevated bond strength can be achieved, without adhesive, by a second UV energy exposure after the films have been placed in contact with each other.

Embodiments of the process of producing the adhesive-free laminates include at least four steps. The first step is printing a UV radiation sensitive ink on a surface of the first film. After printing, the first film and a second film are brought together to create intimate contact (i.e. direct contact) between the second film and the ink. The first film is placed in contact with the second film such that the UV radiation sensitive ink is between the films and the UV radiation sensitive ink is in direct contact with the second film. The contact may be achieved by any number of known processes, such as nipping the films between two rollers, applying pressure to the films, et al. The first film and the ink may be exposed to a first UV radiation prior to contacting the second film to the ink. Alternatively, the first UV irradiation may occur after the second film has been brought into contact with the ink. Finally, the combination of the first film, the ink and the second film is exposed to a second UV radiation to complete the process.

The second UV radiation may be of the same processing conditions as the first UV radiation or the second UV radiation may be completed under different processing conditions as the first UV radiation. The second UV radiation occurs at a later point in time as compared to the first UV radiation, and occurs after the first film and the ink have been brought into contact with the second film.

Advantageously, the processes to produce the adhesive-free laminates disclosed herein do not include the application of a liquid adhesive. Additionally, the processes disclosed herein to produce the adhesive-free laminates may not utilize high heat to induce thermal bonding.

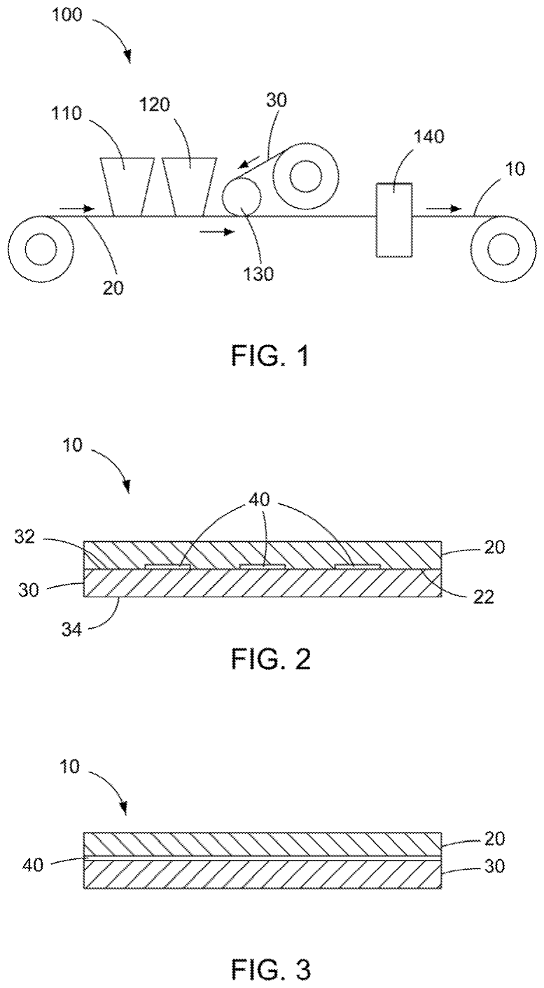

A preferred embodiment of the process to produce the adhesive-free laminate 10 incorporates all four of the necessary steps 110, 120, 130, 140 into a single continuous process 100 (i.e. all steps completed in-line), as shown in FIG. 1. A roll of the first film 20 is unwound and passes through the first step, printing 110. Here, an ink (not shown) is applied directly to a surface of the first film 20. Next, the combination of the first film and the ink is exposed to a first UV radiation 120 such that the ink is at least partially cured. Following the first UV radiation exposure is a contacting step 130. One embodiment of a contacting step is shown in FIG. 1 where a second film 30 is unwound from a roll and placed in contact with the combination of the first film and the ink. The films are brought into contact with each other such that the ink is between the films. The combination of the first film, the ink and the second film is then exposed to a second UV radiation 140. The second UV radiation step should complete the ink cure to the extent that it was not completed after the first UV radiation step. The critical role of the second UV radiation step is increasing bond strength between the ink and the films. Finally, the adhesive-free laminate is wound onto a roll to await further converting. Alternatively, the steps of the process to produce the adhesive-free laminate may occur in more than one operation (i.e. not in-line). Additionally, as will be described, the process to produce the adhesive-free laminate may be completed in a slightly different order of operations and the process may include additional steps, either in-line or out-of-line, to complete an embodiment of the adhesive-free laminate structure.

The ink can be applied to the first film by any type of film printing process. Typical printing processes used for film converting are flexographic gravure, rotogravure, digital, or off-set. The ink is applied in a liquid form and several different colors of ink may be applied to create the desired visual appearance. The ink may cover the entire web or nearly the entire web (i.e. ink is coextensive with the film) or may be patterned in any way. The ink may be applied in several layers, one layer partially or fulling overlapping another layer. There may be more than one color of ink applied to the first film.

The first film may be oriented and is ideally resistant to deformation at the temperatures and tensions experienced during printing. Commonly used substrates (first film) for printing are oriented polyester and oriented polypropylene. The ink may be of any type as long as it is sensitive to UV radiation and can be cured and bonded to the first and second film under the process described herein. The ink may be a UV curable ink. If multiple layers of ink or multiple colors of ink are applied to the web, there may be a UV radiation step after each layer/color application. The individual UV irradiations that the first film and the ink may be exposed to during printing may collectively serve as the first UV radiation exposure of the processes described herein.

The first film of the adhesive-free laminate is a polymeric based film. As used herein the term “film” is a mono-layer or multi-layer web that has an insignificant z-direction dimension (thickness) as compared to its x- and y-direction dimensions (length and width), not unlike a piece of paper. Films are generally regarded as having two major surfaces, opposite each other, expanding in the length and width directions. Films may be mono-layer or multilayer. As used herein, “layers” are homogeneous building blocks of films that are bonded together. Layers may be continuous or discontinuous (i.e. patterned) with the area of the film.

The films that would be useful as the first film may have a thickness from 8 microns to 100 microns. Ideally, the first film has a thickness from 12 microns to 75 microns. Ideally, the first film has high clarity, high gloss and high UV transmissivity. Several types of polymer materials may be utilized in the first film with high success. The first film may have a special coating or treatment to enhance the printability of the film.

The first film may be oriented. The film may be biaxially oriented or mono-axially oriented in either direction. The first film is preferably heat set (i.e. annealed) such that it is dimensionally stable under elevated temperature conditions that might be experienced during conversion of the laminate or during the use of the laminate.

The first film may be an oriented polypropylene film, such as biaxially oriented polypropylene. The oriented polypropylene film may have one or more layers and may have specialized coatings, such as matte finish. The oriented polypropylene film may have some layers that do not contain polypropylene but must have at least one surface layer that contains polypropylene. Any of the layers of the oriented polypropylene film may contain a pigment, such as titanium dioxide, to make the film opaque to visible light. The first film may be a cavitated biaxially oriented polypropylene, also resulting in a film opaque to visible light. The biaxially oriented polypropylene may be transmissive to visible light. In some embodiments, the first film is a biaxially oriented polypropylene film that essentially comprises polypropylene.

The first film may be an oriented polyester film, such as biaxially oriented polyester. The oriented polyester may have one or more layers and may have specialized coatings, such as acrylic. The oriented polyester may have some layers that do not contain polyester. Ideally, the oriented polyester film has at least one surface layer that contains polyester. Any of the layers of the oriented polyester may contain a pigment, rendering the film opaque to visible light. The oriented polyester may be clear to visible light. In some embodiments, the first film is a biaxially oriented polyester film that essentially comprises polyester.

Typically, oriented polyester films have low transparency to portions of the UV spectrum of energy, as compared to other polymeric films. This may be problematic if the UV energy source being used emits wavelengths in the range that is blocked by the polyester. However, use of polyester may be acceptable to the process described herein if the second film is highly transmissive to UV energy or if the UV wavelengths being used are in the portion that is transmitted by polyester. In this regard, it may be useful to use a very high intensity or wide-spectrum UV radiation source.

Non-limiting examples of commercial films that would be suitable for use as the first film of the adhesive-free laminate are as follows: Grade 3-201(8-50 micron) biaxially oriented polyester film available from Jindal Poly Films, Skyrol Grade SP65 (8-36 micron) biaxially oriented polyester available from SKC, Sarafil Grade TFC (8-50 micron) biaxially oriented polyester available from Polyplex, FLEXPET™ Grade F-PAP (8-75 micron) available from Flex America, Hostaphan® Grade 2602N chemically primed biaxially oriented polyester available from Mitsubishi Polyester Film. Hostaphan® Grade 2CSRN chemically primed biaxially oriented polyester available from Mitsubishi Polyester Film, Hostaphan® Grade 2MRLN chemically primed biaxially oriented polyester film available from Mitsubishi Polyester Film, Grade F-AUT (10-23 micron) biaxially oriented polyester available from Flex America, Bicor™ Grade SLP (15-30 micron) biaxially oriented polypropylene available from Jindal Films, Bicor™ Grade CSR-2 (15-30 micron) biaxially oriented polypropylene available from Jindal Films, Grade T523-3 (12-31 micron) biaxially oriented polypropylene available from Taghleef Industries, Grade RLS (12-31 micron) biaxially oriented polypropylene available from Taghleef Industries, Grade PST-2 (15-36 micron) biaxially oriented polypropylene available from Taghleef Industries, Grade AQS (18-31 micron) biaxially oriented polypropylene available from Taghleef Industries, and Grade CTL (12-31 micron) biaxially oriented polypropylene available from Taghleef Industries. The first film can be of any thickness suitable for the application it is intended for.

Inks for printing polymeric films are widely known and may be of a type that can be applied in a variety of methods (i.e. flexographic printing, gravure printing, digital printing, offset printing, etc.). The ink may contain an inorganic or organic pigment, surfactants or other dispersing agents, resins for managing binding or mechanical properties, rheology modifiers, defoamers, wetting agents, solvents, or pH modifiers. The ink may contain other additives to adjust viscosity or other processing variables.

The ink of the adhesive-free laminates described herein should be one that is sensitive to radiation, especially ultraviolet (UV) radiation. UV radiation sensitive inks have various components that react to energy that has wavelengths in the UV range (roughly 200 to 400 nm), such that the ink polymerizes and/or crosslinks, increasing the ink viscosity, and ultimately changing from a liquid to a solid. Typically, this reaction is started by exposure to UV radiation and then either stops or slowly continues after the UV energy exposure is terminated. In some cases, the UV radiation is first absorbed by photoinitiators within the ink formula. The photoinitiators absorb the energy and create free radicals which further react with the ink components.

It is common in the label and packaging converting industries to use UV curable inks. The inks are specifically formulated to be of a liquid type viscosity prior to UV exposure, easily applied to a film by a process such as offset printing, digital printing or flexographic gravure printing. The inks are “sensitive” to UV radiation, typically by way of the addition of photoinitiators. The photoinitiators absorb energy at wavelengths specifically within the UV spectrum (approximately 200 to 400 nm). Upon absorption of the UV energy, the photoinitiators dissociate to form free radicals. Other components within the ink (monomers, oligomers and reactive diluents) may contain double bonds capable of reacting with the free radicals. The reaction continues during, and possibly for a time following, the UV radiation exposure. The reaction builds longer chains of polymers and may even cause crosslinking between polymer chains, resulting in a rise in molecular weight and viscosity such that the ink transforms to a solid. This process is typically referred to as “curing”. The reaction changes the ink from “uncured”, through “partial cure”, to “fully cured”. As discussed, uncured ink has low viscosity. A partially cured ink has higher viscosity and may have characteristics spanning liquids (i.e. flowable) and solids (i.e. rigid). An ink that has been fully cured is solid. At full cure, the reaction ceases, likely due to the depletion of free radicals. Conventional, non-UV sensitive inks used for packaging and label applications, such as solvent based polyurethane chemistry inks or nitrocellulose chemistry inks, are not reactive to UV energy and would not be suitable to use in the adhesive-free laminates or processes used to produce the adhesive-free laminates described herein, without modification.

Non-limiting examples of commercial UV radiation sensitive inks that would be suitable for use in the adhesive-free laminate are as follows: Fujifilm 300 series inks such as 300-325, INX INXFlex™ UV LM, and Siegwerk SICURA Flex 39-10.

In addition to traditional UV radiation sensitive inks, it is contemplated that other ink formulations may be suitable for use in adhesive-free laminates. For example, inks that do not contain photoinitiators, but otherwise react upon exposure to UV radiation may be developed and would be appropriate for embodiments of adhesive-free laminates.

The ink may be configured to relay a visual message. In order to relay the message, the ink should be visible from either or both sides of the adhesive-free laminate. The visual message may be intended to be viewed by a human and may take the form of product logos, product instructions/information, branding colors/shapes, etc. The visual message may be intended to be read by a machine and may take the form of a code (i.e. bar code or serial number).

The first UV radiation exposure initiates the ink curing reaction. The UV curing reaction may be influenced (i.e. faster curing or curing to a greater extent) by increased temperature. Curing may continue until the free radicals have been depleted (full cure) or it may end due to lack of energy (partial cure). Under appropriate conditions, as the ink polymerizes and/or crosslinks, the ink may also form bonds across the interface of the ink and the layer (film or other material) that is located adjacent to the ink. Thus, curing the UV radiation sensitive ink may increase the bond strength the ink has to the film the ink has been applied to, or another film the ink may be in contact with. The increase in bond strength may be dependent upon the film, some films providing better bonding opportunities than others. The action of the first UV radiation exposure is predominately to cure the ink but may have some influence on increasing the ink/film bond strength.

The UV radiation steps of the process to produce the adhesive-free laminate may be implemented in a variety of ways and may need to be adjusted within a set of variables to achieve an acceptable product, based on the final application requirements. The variables include the wavelength, irradiance, time of the UV radiation and temperature of the radiation target (i.e. film and/or ink). For example, most UV printing processes utilize UV radiation from lamps that emit an irradiance of about 50 W/cm² and have a peak or target wavelength of 365 or 390 nm. The processor must ensure that the printed web travels through the curing station at a speed such that enough irradiance impacts the ink to effectively cure, or at least kick off the curing reaction. Other options exist for UV radiation sources, including high intensity, wide spectrum lamps such as high-pressure mercury lamps.

As mentioned, temperature may play a role in the speed of the UV curing reaction. Depending on the ink and UV light source used, a slightly elevated temperature may be necessary to achieve curing at a practically acceptable rate. Temperature may also play a role in the extent of curing and bond strength level achieved. Increasing the temperature at which the curing is occurring may be achieved by heating the web slightly just prior to UV exposure. For example, the combination of the first film, the ink and the second film may be heated by passing the web over a heated roller before it enters the UV exposure chamber. In cases where the first film and the second film are brought into contact with each other just prior to the second UV exposure (as will be described in more detail), the temperature of the web may be adjusted by heating the rolls used to nip the films together. If the film is traveling at a high speed through the machine, it may be necessary to have the rollers at a fairly high temperature to effectively raise the temperature of the film/ink combination to a suitable range. For example, the roller may be set at 300° F. to heat the web traveling at 100 ft/min to about 140° F. This is dependent on the amount of “wrap” the web has on the roller, or the length of surface of the roller that the web touches as it passes, as well as the speed of the web.

Often, the ink curing reaction is exothermic, effectively raising the temperature of the ink and any films in contact with the ink. In some cases, cooling rolls may be used to keep the temperature of the film at a level to avoid issues such as material degradation or sticking.

The first UV radiation may impinge the web (i.e. film, ink or a combination of these) from any direction. Typically, UV curing of the ink is done by exposing the ink directly to the UV radiation, without an intervening film. In other words, the UV radiation source is on the same side of the first film as the ink, directed toward the surface of the first film upon which the ink has been applied. However, if the first film is transparent to the wavelength of UV radiation being used, the radiation may be applied through the first film, still impinging the ink and beginning the ink cure process. It is also contemplated that the first UV radiation may impinge the first film from both sides at the same time by using two separate UV radiation sources placed on either side of the web.

In addition to curing the ink, the UV radiation may also influence the polymers in the films that are in the path of the radiant energy. Different polymers react to different wavelengths of energy in various ways. In some cases, the polymers are unchanged. In other cases, the bonds of the polymer may undergo scission. In still other cases, bonds of the polymer may react with other bonds, causing polymer crosslinking or rearrangement. The change in a polymer under exposure to UV energy may be evident by various physical changes, such as yellowing. When a polymer film does change under UV radiation, the polymer may absorb some or all the energy, and the polymer may be considered partially or fully “UV blocking”. If a polymer film absorbs all the UV energy, no UV radiation travels through the film and the film is opaque to UV energy.

After the first film has been printed, the second film is bought into contact with the first film such that the ink is trapped between the first film and the second film. As used herein. “contact” of the films means that the ink is in direct contact with the first film and the ink is in direct contact with the second film. The contact can be achieved by any known process, as long as a surface of the second film is brought into intimate contact with the ink that has been applied to the first film. As shown in FIG. 1, the contacting step 130 may include a nip roller, applying pressure to the films and creating intimate contact between them. Advantageously, a nipping type of contacting process can help to remove any air that might be entrapped between the webs, increasing the contact between the films. Because oxygen is known to consume (i.e., react with) free radicals, it may be advantageous for at least one UV exposure to take place after the second film has been contacted to the first film in a process that eliminates as much air as possible.

The contact step 130 may or may not include heating the first and/or second film. In some embodiments, the contact step is executed without the addition of heat. In some embodiments, the contact step is executed with the addition of heat, the films remaining below the temperatures of their respective softening points. In some embodiments, the contact step is executed with the addition of heat such that one or both of the films reach their softening point. Preferably, the contact step includes very low or no heating.

The second film of the adhesive-free laminate is a polymeric based film. The films that would be useful as the second film may be mono-layer or multi-layer and may have a thickness from 10 microns to 400 microns or more. Ideally, the second film has a thickness of between 12 microns and 100 microns. The second film preferably has high UV transmissivity. Preferably, the second film is highly transparent to UV energy over a wide range of the UV spectrum. However, the second film may have lower transparency to UV energy or may only be transmissive over a portion of the UV spectrum. Several types of polymer materials may be utilized as the second film with high success.

The second film may be a multilayer film containing a wide variety of different polymers. For example, the second film may have a layer that is in contact with the UV sensitive ink, an oxygen barrier layer, one or more tie layers, a bulk layer and a sealant layer. The surface of the second film that is in contact with the UV sensitive ink may contain polyethylene homopolymer or copolymer. The surface of the second film that is in contact with the UV sensitive ink may be a layer of polybutadiene.

Some embodiments of the adhesive-free laminate will include a second film that includes a heat sealant layer, enabling the laminate to be used in applications of high-performance hermetic packaging. As used herein, a “sealant”. “sealant material” or “sealant layer” is one that can form a bond with itself or another surface under the influence of heat and/or pressure. The sealant layer may be on the surface of the second film facing away from the UV radiation sensitive ink. Alternatively, a sealant material may be coated onto the outer surface of the second film. A coated sealant may be pattern applied. A sealant may be attached to the laminate in the form of a film (i.e. a third film) connected to either the first film or the second film.

While not always necessary, it may be useful to heat either the first film or the second film or both films as they are brought into contact with each other. This may assist in achieving good wetting between the surfaces. However, in some embodiments the temperatures used should not be above the softening point of the surfaces of the films that are being contacted.

In some embodiments of the process, excessive temperatures at the time of contacting the films (i.e. temperatures above the softening point of the materials or even above the melting point of the materials) are avoided. The high temperatures, such as those high enough to achieve thermal lamination, can be detrimental to the materials within the laminate. For some embodiments, only low temperature increases may be necessary for the disclosed processes to result in acceptable laminates. For example, if the surface of the second film that contacts the ink comprises polybutadiene, no additional heat is required as the material wets out well enough under pressure alone.

In some embodiments, the contacting step is completed at temperatures that slightly soften the surface of the second film. In some cases, the temperature of the laminate may not exceed 250° F. In other cases, no additional heat is required through the production process.

Following the contacting of the second film to the first film, the material is subjected to a second UV radiation. The second UV radiation may be at the same or different target wavelength as the first UV radiation. The second UV radiation may be at the same or different intensity and duration as the first UV radiation. The second radiation step may increase the bond strength between the UV radiation sensitive ink and the first film. The second radiation step increases the bond strength between the UV radiation sensitive ink and the second film. Additionally, any ink curing that was not completed by the first UV radiation exposure is completed by the second UV radiation exposure. Especially important during the second UV radiation step is to increase the bond strength between the ink and the second film. In some cases, prior to the second UV radiation, the bond strength between the ink and the second film is at or near zero.

As with the first UV radiation exposure, it may be beneficial to increase the temperature of the laminate prior to the second UV radiation exposure. A higher temperature may change the speed of the reaction so that the ink curing and bonding occur faster and to a greater extent. The second UV radiation exposure may be most efficient when the laminate (the combination of the first film, the UV sensitive ink and the second film) temperature is between 100° F. and 200° F. In some embodiments of the adhesive-free laminate process, the laminate may not be heated and may even be cooled prior to the second UV radiation exposure.

As with the first UV radiation, the second UV radiation can impinge the film structure from either the side of the first film or the side of the second film, or both. If one of the first film or the second film is more transparent to UV radiation, it will likely be more efficient to direct the radiation from that side of the structure. In most cases, it will be most beneficial to impinge the second UV radiation through the second film such that it can be at least partially absorbed at or near the interface of the ink and the second film.

The process of producing the adhesive-free laminates includes two separate UV radiation exposures occurring at two different points in time. The first UV radiation exposure occurs after the first film has been printed with the UV radiation sensitive ink. The second UV radiation exposure occurs after the second film has been contacted to the first film. Both the first and second UV radiation may occur after the second film has been contacted to the first film. Alternatively, the first UV radiation may occur prior to contact of the second film to the first film.

Some embodiments of the process to produce the adhesive-free lamination include contacting the second film to the first film directly after printing the first film, without curing the ink. Essentially, the ink is “wet” at the time that the printed first film is brought into contact with the second film, as there has been no UV exposure to begin the curing and increase the viscosity of the ink. The first UV exposure happens after contact of the films is completed. This order of events can be beneficial to bonding as it allows for a very good wetting of the ink on the surface of the second film. Good wetting increases the surface area between the ink and the second film, ultimately resulting in better bonding after the first and second UV radiation exposure. Similarly, if the first UV radiation exposure occurs prior to contact of the first film to the second film, it may be advantageous to only partially cure the ink. Again, the ink, in a less than fully cured state, may wet out against the second film better, resulting in a better bond strength after the second UV radiation exposure.

The adhesive-free laminates generally have a structure of a first film, a second film and an ink located between the films. The ink is in direct contact with a surface of the first film and a surface of the second film. The first film, the ink and the second film are all bonded to each other at their contacting surfaces. There is no adhesive material between the first film and the second film of the adhesive-free laminate.

Referring now to FIGS. 2 and 3, embodiments of the adhesive-free laminate 10 comprise of the first film 20, the second film 30 and the ink 40. The ink 40 is adhered to a surface of the first film 22 and the ink 40 is adhered to a surface of the second film 32 and the ink is located between the first and second film 20,30. As shown in FIG. 2, the ink 40 may be patterned and not continuous with either the first or second film 20,30. In some embodiments of the adhesive-free laminate 10, the ink 40 is coextensive with both the first film 20 and the second film 30, as shown in FIG. 3.

Some embodiments of the adhesive-free laminate have a first film, an ink that contains a pigment and a second film. In some embodiments, the ink is configured to relay a visual message. The ink is one that has been cured by UV radiation. The adhesive-free laminates do not contain adhesive between the first film and the second film. The ink of the adhesive-free laminates is adhered directly to the surface of the first film and the ink of the adhesive-free laminates is adhered directly to the surface of the second film.

The ink is bonded to the first film and/or the second film and the bond strength is enhanced by exposure to UV radiation. Evidence of this may be by detection of an increased bond strength after exposure to a UV radiation source. Without being bound by theory, the reaction of the UV radiation sensitive ink under UV radiation exposure may include creation of chemical bonds across the ink/film interface, thus providing increased bond strength. The ink bond strength to the first and/or second film may increase after exposure to the first UV radiation source. The ink bond strength to the first and/or second film increases after exposure to the second UV radiation source, as described by the process to produce an adhesive-free laminate described herein.

As shown in FIGS. 2 and 3, some embodiments of the adhesive-free laminate 10 include the first film 20 and the second film 30 attached to each other with only the ink 40 intervening. The ink 40 is adhered to both the first film 20 and the second film 30. In other words, the bond strength between the ink and the first film is greater than zero and the bond strength between the ink and the second film is greater than zero. There is no adhesive material assisting with the attachment of the ink to the first film. There is no adhesive material assisting with the attachment of the ink to the second film. In the areas where the surface of the first film 22 is in contact with the surface of the second film 32, the film may or may not be bonded.

Ideally, if there are portions of the surfaces of the films 22,32 that do not have ink in contact with them, the two films are in intimate contact and have a bond strength greater than 0 g/in, preferably greater than 20 g/in. If there are portions of the films that do not have ink between them, the bond strength in these areas may increase after exposure to the second UV radiation.

In the process of converting labels and packaging laminates, adhesives that may be used to connect layers come in a variety of formats and generally have the purpose of enabling dissimilar materials to be bonded together. Typical adhesives are one- or two-component materials, applied to a film in liquid form prior to connecting to another film. These adhesives typically use polyurethane, acrylic, or epoxy amine type chemistry. Liquid applied adhesives have several disadvantages including solvent removal and disposal (high cost and energy impact) and extended cure time (costly for production). In some cases, the addition of liquid applied adhesive layers for bonding negatively affects other characteristics of the laminate, such as stiffness.

Also used in labels and packaging laminates are polymer-based adhesives that are extruded into or onto a film. Typical polymer-based adhesives take the form of tie layers within coextruded films, adhesive layers within extrusion laminations or adhesive layers within extrusion coating, to name a few. The polymers used for these types of adhesives take various forms, but generally have lower softening points and a high level of active bonding sites to help with adhesion to various materials. Examples of these types of adhesives are maleic anhydride grafted polyolefins, ethylene vinyl acetate copolymers or similar materials. These materials bond to adjacent materials when they come into contact while in the melted state (i.e. coextrusion).

Polymers used as adhesives in coextrusion or extrusion lamination may also be used as adhesive in thermal lamination processes. During this type of process, the adhesive material is not in the melt phase, but rather in a softened state by way of heat. Once softened by heating, the adhesive material is brought into contact with another material, creating intimate and often intermingled physical contact. Upon cooling, this intermingled contact creates a bond between the materials.

Pressure-sensitive adhesives (PSAs) may also be used as adhesives in laminates. PSAs are typically a blend of lower molecular weight materials that results in a material that remains soft and tacky.

In contrast, the adhesive-free laminates described herein do not use adhesives of these types to create a bond between the first film, the ink and the second film. The bond is created by specific processing of the laminate, including two separate UV radiation exposures. This process has the advantages of efficiency (no adhesive application) and low cost (no adhesive materials). The adhesive-free laminate produced by this process can also have the advantage of ease of design (i.e. films and inks do not need to withstand high heats).

The adhesive-free laminates made by the process described herein do not contain typical adhesive type components. There is not material that was applied as a liquid with the sole purpose of bonding two surfaces to each other. For some embodiments, is no material present that is used for bonding two surfaces under the application of heat. As opposed to materials that soften upon heating, a suitable material for the contacting surface of the second film is polybutadiene. Polybutadiene is relatively soft at ambient temperatures and can achieve good wetting when brought into contact with the ink without the addition of heat.

The softening point of a polymer or a film is often defined by a given measurable attribute using a known method such as the Vicat method (ASTM-D1525) or a heat deflection method (ASTM-D648). In some cases, a polymer has a glass transition point which can define a softening point. As described herein, the softening point of a polymer or film is a temperature above which the material takes a state in which it can be attached to another surface and a strong bond strength is achieved after cooling the material below that temperature. The material above the softening point is in a softened condition and may have more physical mobility such that it can increase the bonding surface area when brought into intimate contact with another surface. Sometimes, this increase in surface area is called “wetting”. Materials that have been heated above their softening point may have increased wetting to another surface, increasing the opportunity for raising the bonding strength between them.

Some embodiments of the adhesive-free laminate may include other layers or materials. For example, there may be additional ink on the first film or the second film, located on a surface opposite that of the UV radiation sensitive ink. Additional films, coatings, layers or materials may also be added to the laminate, without exclusion, as long as the UV radiation sensitive ink is adhered to the surface of the first film and the UV radiation sensitive ink is adhered to the surface of the second film and the UV radiation sensitive ink is between the first film and the second film. Additional materials of any kind may be added for any reason, such as barrier enhancement, aesthetic improvements, or increased durability.

Some embodiments of the adhesive-free laminate will include a barrier material, suitable for reducing the transmission of oxygen, moisture, or other molecules through the laminate. Non-limiting examples of barrier materials that may be included in the adhesive-free laminates include oxygen or moisture scavengers, ethylene vinyl alcohol copolymers, metal foils, vapor depositions of metals or inorganics, high-density polyethylenes, cyclic olefin copolymers, polyamides, polyesters and exfoliated clay. The barrier material may be part of the first film, part of the second film, or introduced to the laminate as an additional film, coating or additive.

As stated, there are not adhesive materials within the portion of the laminate defined by the surface of the first film, the UV radiation sensitive ink and the surface of the second film. However, adhesives may be used in other portions of the laminate, such as the surface of the second film directed away from the UV radiation sensitive ink. Other films may be laminated to the embodiments described herein using conventional adhesive and conventional laminating processes. For example, an embodiment of the adhesive-free laminate may include a PSA material on the exterior surface (the surface opposite that which is in contact with the ink) of either the first or second film such that the laminate is functional as a PSA label.

A critical attribute of laminates is the bond strength. The components of the adhesive-free laminate should be assembled in a way that they will not delaminate from each other during use. The application in which a laminate is utilized often dictates the required bond strength. For example, packaging or label applications where the laminate experiences high stress and abuse may have a very high bond strength requirement, such that the laminate does not fail during use. Some applications of use have very low requirements either due to low risk or low abuse, and these laminates may require only minimal bond strengths. Bond strengths of laminates can be measured according to ASTM F904 (12 in/min draw speed, conditioning and testing at 23° C./50% RH) which measures the force required to separate layers of a laminate. As discussed herein, the bond strength of the adhesive-free laminate is measured using ASTM F904 to determine the force required to separate the first film from the second film.

The bond strength between the first film and the second film of the adhesive-free laminate may be in the range of 30 g/in to 1,000 g/in, or higher. The bond strength between the first film and the second film of the adhesive-free laminate may be in the range of 50 g/in to 750 g/in. The bond strength between the first film and the second film of the adhesive-free laminate may be between 50 g/in and 300 g/in. The bond strength of the adhesive-free laminate will likely vary within the same sample, depending on the color of the ink, the amount of ink or the presence of ink in certain areas (i.e. patterned ink as in FIG. 2). In some cases, when measuring the bond between the first film and the second film, the bond strength between the films will be quite strong, causing one of the films to tear. The measured force of the film tearing is considered the bond strength for that sample (film tear is the mode of failure). The bond may open at the interface of the ink and the films or it may split within the ink. The location of bond fracture may vary and change as the bond strength is tested.

Surprisingly, strong bonds can be achieved within a lamination of film/ink/film without the need of an adhesive or the addition of excessive heat. This is extremely advantageous to the processor of the laminate structure as an adhesive material and/or potentially damaging heat can be eliminated. The elimination of adhesive material provides a cost advantage over adhesive lamination.

The thickness of the adhesive-free laminate may be from 20 micron to 500 micron or more. While the portion of the adhesive-free laminate that is defined by the first film, the ink and the second film may be thin and flexible, some embodiments of the adhesive-free laminate may be quite thick and/or rigid due to additional layers or materials.

The adhesive-free laminates described herein may be used for a wide variety of applications. One exemplary application is packaging films. Films used to package food, pharmaceuticals, medical products, industrial items or consumer goods often use adhesive based laminate materials. Packaging would benefit from adhesive-free laminates due to converting process improvements and lower material costs. In particular, hermetically sealed packaging that provides barrier protection for the product would especially benefit from the adhesive-free laminates described herein.

### Examples & Data

Data 1

A white BOPP film was printed with a UV sensitive overlaquer ink (Fujifilm 300-HGV). The UV radiation sensitive ink was exposed to a first UV radiation such that the ink was partially cured, remaining just slightly tacky. One-inch strips of the printed film were cut from the web and overlaid with a one-inch strip of a film having a surface comprising polybutadiene such that the ink was between the white BOPP film and the polybutadiene film. This sandwich was placed in a hydraulic lab press (Carver Press) and subjected to 1 ton of pressure at ambient lab temperature (no additional heat) to ensure good contact of the films. Several sample laminates were made according to this procedure.

A strip of the laminate was then placed inside of a lab crosslinking unit (Spectrolinker™ XL-1500 UV Crosslinker with bulbs having a primary emission peak centered at 254 nm). The samples were subjected to radiation for varying times, up to 40 seconds, the radiation impinging the laminate from the polybutadiene side. This second radiation was carried out at ambient temperature (no additional heat added).

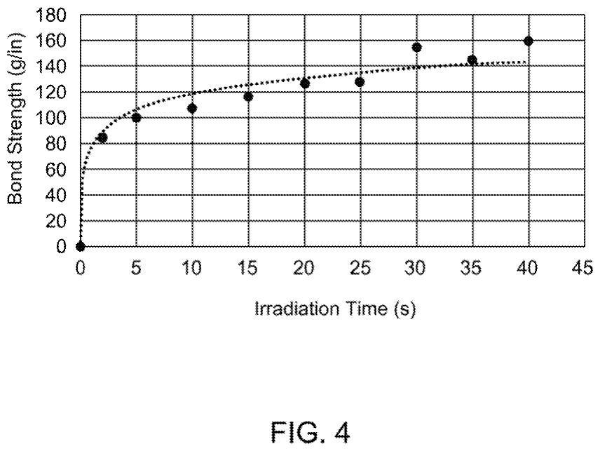

The bond strengths of this material were tested using a tensile testing unit (MTS Insight®, MTS Systems Corporation), separating the BOPP from the polybutadiene film in a 180° peel. Data from this bond strength testing can be seen in FIG. 4. The data indicates that without excessive heat at the time of combining the films (not thermal lamination) and without adhesive, an acceptable bond strength can be achieved by impinging the laminate with a second UV radiation exposure.

Data 2

A clear BOPP film was printed with various colors (cyan, magenta and green) UV radiation sensitive ink (Fujifilm 300-HGV). The UV radiation sensitive ink was exposed to a first UV radiation such that the ink was fully cured. One-inch strips of the printed film were cut from the web and overlaid with a one-inch strip of 1.5 mil polyethylene (PE) film such that the ink was between the BOPP film and the PE film. This combination of the first film (BOPP), ink and second film (PE) was placed in a hydraulic lab press (Carver Press) and subjected to 1 ton of pressure at a temperature of about 257° F. for approximately 2 minutes, to ensure good wetting of the PE film to the ink. Several laminate samples were made according to this procedure.

A strip of the laminate was then attached to a hot plate inside of a lab crosslinking unit (Spectrolinker™ XL-1500 UV Crosslinker with bulbs having a primary emission peak centered at 254 nm). The hot plate was set to temperature of 140° F. Once heated to 140° F., the laminate samples were subjected to radiation for approximately 40 seconds. Using this method, the laminate samples were exposed to UV radiation from each side, sequentially. In other words, the second radiation exposure included irradiating the sample laminate from the BOPP side using this technique, then irradiating the sample laminate from the polyethylene side using the same technique.

The bond strengths of these laminate samples were tested using a tensile testing unit (MTS Insight®, MTS Systems Corporation), separating the BOPP from the PE film in a 180° peel. The resulting bond strengths were 850 g/in (green), 650 g/in (magenta) and 1,000 g/in (cyan). This is a significant increase over a similar laminate that uses a UV cured adhesive system, which results in bond strengths of about 50 g/in.

### Embodiments

A A process to produce an adhesive-free laminate comprising,
   a printing a UV radiation sensitive ink on a surface of a first film;
   b exposing the first film and the UV radiation sensitive ink to a first UV radiation;
   c contacting the first film to a second film such that the UV radiation sensitive ink is between the first film and the second film and the UV radiation sensitive ink is in direct contact with a surface of the second film, resulting in a combination of the first film, the UV radiation sensitive ink and the second film; and
   d exposing the combination of the first film, the UV radiation sensitive ink and the second film to a second UV radiation.
B The process to produce an adhesive-free laminate according to any of embodiments A through P, wherein the first film is oriented.
C The process to produce an adhesive-free laminate according to any of embodiments A through P, wherein the first film comprises polyester.
D The process to produce an adhesive-free laminate according to any of embodiments A through P, wherein the second film comprises a heat sealant layer and at least one other layer.
E The process to produce an adhesive-free laminate according any of embodiments A through P, wherein either the first or second film comprise an oxygen barrier layer.
F The process to produce an adhesive-free laminate according to any of embodiments A through P, wherein the UV radiation sensitive ink is configured to relay a visual message.
G The process to produce an adhesive-free laminate according to any of embodiments A through P, wherein the UV radiation sensitive ink is less than fully cured upon exposure to the first UV radiation.
H The process to produce an adhesive-free laminate according to any of embodiments A through P, wherein after exposing the combination of the first film, the UV radiation sensitive ink and the second film to a second UV radiation, a bond strength between the first film and the second film is between 30 g/in and 1,000 g/in.
I The process to produce an adhesive-free laminate according to any of embodiments A through P, further comprising heating the combination of the first film, the UV radiation sensitive ink and the second film using an external heating source immediately prior to exposure to the second UV radiation.
J The process to produce an adhesive-free laminate according to any of embodiments A through P, wherein the external heating source heats the combination of the first film, the UV radiation sensitive ink and the second film to a temperature between 100° F. and 200° F.
K The process to produce an adhesive-free laminate according to any of embodiments A through P, wherein the second UV radiation impinges the second film before the first film.
L The process to produce an adhesive-free laminate according to any of embodiments A through P, wherein the first UV radiation and the second UV radiation impinge opposite sides of the UV radiation sensitive ink.
M The process to produce an adhesive-free laminate according to any of embodiments A through P, wherein the first UV radiation and the second UV radiation impinge the same side of the UV radiation sensitive ink.
N A process to produce an adhesive-free laminate comprising:
   a a first step of printing a UV radiation sensitive ink on a surface of a first film;
   b a second step of exposing the first film to a first UV radiation;
   c a third step of contacting the first film to a second film such that the UV radiation sensitive ink is between the first film and the second film and the UV radiation sensitive ink is in direct contact with a surface of the second film, the third step resulting in a combination of the first film, the UV radiation sensitive ink and the second film; and
   d a fourth step of exposing the combination of the first film, the UV radiation sensitive ink and the second film to a second UV radiation.
O The process to produce an adhesive-free laminate according to embodiment N, wherein the first, second, third and fourth steps are carried out sequentially in a single continuous process.
P The process to produce an adhesive-free laminate according to embodiment N or O, wherein the third step is carried out when the second film is at a temperature below the second film softening point.
Q An adhesive-free laminate produced according to any of the processes of embodiments A through P.
R The adhesive-free laminate according to embodiment Q wherein a bond strength measured when separating the first film and the second film is at least 50 g/in.
S The adhesive-free laminate according to embodiment Q wherein the adhesive-free laminate is a heat-sealable packaging film.
T A heat-sealed package comprising the heat-sealable packaging film according to embodiment S.

1. A process to produce an adhesive-free laminate comprising,
a printing a UV radiation sensitive ink on a surface of a first film;
b exposing the first film and the UV radiation sensitive ink to a first UV radiation;
c contacting the first film to a second film such that the UV radiation sensitive ink is between the first film and the second film and the UV radiation sensitive ink is in direct contact with a surface of the second film, resulting in a combination of the first film, the UV radiation sensitive ink and the second film; and
d exposing the combination of the first film, the UV radiation sensitive ink and the second film to a second UV radiation.

2. The process to produce an adhesive-free laminate according to claim 1, wherein the first film is oriented.

3. The process to produce an adhesive-free laminate according to claim 2, wherein the first film comprises polyester.

4. The process to produce an adhesive-free laminate according to claim 1, wherein the second film comprises a heat sealant layer and at least one other layer.

5. The process to produce an adhesive-free laminate according to claim 1, wherein either the first or second film comprise an oxygen barrier layer.

6. The process to produce an adhesive-free laminate according to claim 1, wherein the UV radiation sensitive ink is configured to relay a visual message.

7. The process to produce an adhesive-free laminate according to claim 1, wherein the UV radiation sensitive ink is less than fully cured upon exposure to the first UV radiation.

8. The process to produce an adhesive-free laminate according to claim 1, wherein after exposing the combination of the first film, the UV radiation sensitive ink and the second film to a second UV radiation, a bond strength between the first film and the second film is between 30 g/in and 1,000 g/in.

9. The process to produce an adhesive-free laminate according to claim 1, further comprising heating the combination of the first film, the UV radiation sensitive ink and the second film using an external heating source immediately prior to exposure to the second UV radiation.

10. The process to produce an adhesive-free laminate according to claim 9, wherein the external heating source heats the combination of the first film, the UV radiation sensitive ink and the second film to a temperature between 100° F. and 200° F.

11. The process to produce an adhesive-free laminate according to claim 1, wherein the second UV radiation impinges the second film before the first film.

12. The process to produce an adhesive-free laminate according to claim 1, wherein the first UV radiation and the second UV radiation impinge opposite sides of the UV radiation sensitive ink.

13. The process to produce an adhesive-free laminate according to claim 1, wherein the first UV radiation and the second UV radiation impinge the same side of the UV radiation sensitive ink.

14. A process to produce an adhesive-free laminate comprising:
a a first step of printing a UV radiation sensitive ink on a surface of a first film;
b a second step of exposing the first film to a first UV radiation;
c a third step of contacting the first film to a second film such that the UV radiation sensitive ink is between the first film and the second film and the UV radiation sensitive ink is in direct contact with a surface of the second film, the third step resulting in a combination of the first film, the UV radiation sensitive ink and the second film; and
d a fourth step of exposing the combination of the first film, the UV radiation sensitive ink and the second film to a second UV radiation.

15. The process to produce an adhesive-free laminate according to claim 14, wherein the first, second, third and fourth steps are carried out sequentially in a single continuous process.

16. The process to produce an adhesive-free laminate according to claim 14, wherein the third step is carried out when the second film is at a temperature below the second film softening point.

17. An adhesive-free laminate produced according to any of the processes of claim 1 or 14.

18. The adhesive-free laminate according to claim 17 wherein a bond strength measured when separating the first film and the second film is at least 50 g/in.

19. The adhesive-free laminate according to claim 17 wherein the adhesive-free laminate is a heat-sealable packaging film.

20. A heat-sealed package comprising the heat-sealable packaging film according to claim 18.
